(19) United States
(12) Patent Application Publication
(10) Pub. No.: US 2025/0166591 A1
(43) Pub. Date: May 22, 2025

(54) MUSICAL INSTRUMENT

(71) Applicant: Martin Pierre Marc Bergeaud, Cape Town (ZA)

(72) Inventor: Martin Pierre Marc Bergeaud, Cape Town (ZA)

(21) Appl. No.: 18/514,355

(22) Filed: Nov. 20, 2023

(51) Int. Cl. G10D 13/06; G10D 13/16; G10D 13/24; G10G 1/00

(52) U.S. Cl. CPC G10D 13/06; G10D 13/16; G10D 13/24; G10G 1/00

(57) ABSTRACT

A musical instrument, and more particularly, a percussive instrument which can easily be assembled and disassembled, and which is associated with a predetermined pitch. The musical instrument comprises a main body which, when assembled and in use, defines a hollow chamber configured as a sound box. A percussive bar is fixed relative to the main body and spaced therefrom by at least a first spacer member. The main body is characterised in by being configurable in one of an assembled configuration and a disassembled configuration. The musical instrument is further characterised by being tuned to a predetermined pitch during assembly.

### BACKGROUND OF THE DISCLOSURE

This disclosure relates to a musical instrument. More particularly, the present disclosure relates to a percussive instrument which can easily be assembled and disassembled, and which is associated with a predetermined pitch.

Percussion instruments are musical instruments which produce a sound when struck or beaten by an object (such as a percussive mallet or beater, or even a hand of a person). Percussion instruments are often used to provide a rhythm or time stamp to a piece of music.

The use of music for educational and entertainment or team building purposes is well known. It is believed that simple percussive instruments lend themselves particularly well to the use for educational or team building purposes, due to their relative ease of mastering. In some cases, a person simply require dexterity and an ability to react to a predetermined rhythm, to play a percussive instrument.

Furthermore, it is believed that a sense of unity and group identity can be fostered by a large group of associated persons contributing to the creation of a song or a melody in unison.

Constructing or assembling an object, such as a musical instrument, also has the potential of serving an educational purpose and/or as a group activity.

It is believed that bringing together activities of constructing an object and playing a musical instrument could potentially serve educational and team building exercises. To this end, a need exists for a relatively simple and low-cost musical instrument which can easily be assembled and disassembled, and which can be played or mastered without requiring an undue amount of skill and dexterity. A need also exists for a method or system for facilitating a group in participating in the playing of said instrument collectively to create a melody.

It is accordingly an object of the disclosure to provide a musical instrument and a method of playing same that will, at least partially, address the above disadvantages.

It is also an object of the disclosure to provide a musical instrument and a method of playing same, which will be a useful alternative to existing musical instruments and methods.

### SUMMARY OF THE DISCLOSURE

In accordance with a first aspect of the disclosure there is provided a musical instrument, comprising:
a main body operatively defining a hollow chamber configured as a sound box;
a percussive bar operatively fixed relative to the main body and spaced therefrom by at least a first spacer member,
   characterised in that the main body is configurable in one of an assembled and disassembled configuration. The musical instrument may further be characterised by being tuned, during configuration into the assembled configuration, into a predetermined pitch.

Typically, when in the disassembled configuration, the main body may be disassembled into a flat-pack configuration.

When in the assembled configuration, the main body may be hexagonal and may define a hexagonal hollow chamber.

The main body may comprise a plurality of main body segments which may be substantially rectangular with bevelled edges which operatively interact to form the main body and define the hollow chamber.

Alternatively, the main body may be formed from a single paper-based material and may comprise a plurality of main body segments which are defined between lines of weakness, fold lines or slits defining fold lines. A first and last main body segment may define a half lap or shiplap joint which, when the main body is configured in the assembled configuration, may be joined to form the main body and define the hollow chamber. The main body segment associated with the joint may define the spacer member(s).

The main body, when in the assembled configuration, may comprise two open ends. The musical instrument may further comprise a plug member having an external shape commensurate with a cross-sectional shape of the hollow chamber. The plug member may be arranged in one of a number of predetermined positions within the main body to define a volume of the hollow chamber. Each of the predetermined positions may be associated with a predetermined pitch, such that positioning the plug member at a predetermined position configures or tunes the musical instrument into a predetermined pitch.

The predetermined positions may be indicated by markings on an inner surface of the main body. Alternatively, the predetermined positions may be indicated by markings on a stem portion of a mallet which forms part of the musical instrument. In the latter case, the stem portion with the associated markings may be placed proximate the main body during assembly thereof to serve as a guide for placing the plug member in one of the predetermined positions.

The plug member may be positioned within the main body during assembly of the musical instrument, thereby to configure or tune the musical instrument into a predetermined pitch.

The main body may operatively define a sound hole which may be arranged or located proximate the percussive bar. The sound hole may be provided in communication with the hollow chamber.

Typically, the musical instrument may comprise two spacer members operatively arranged on opposite sides of the sound hole.

The musical instrument may further comprise strap members which operatively extend around the main body to releasably retain the main body in the assembled configuration.

The percussive bar may be releasably fixed to either the strap members or the at least first spacer member.

At least a portion of the musical instrument may be marked with an identifier which is linked to a predetermined pitch. The identifier may comprise a colour, a letter, a numeral or a special character.

The percussive bar may be manufactured from wood, such as bamboo. The main body may be manufactured from cardboard.

In accordance with a second aspect of the disclosure there is provided a method for a plurality of persons to play a melody associated with a predetermined song, in unison, the method comprising the steps of:
S1: providing a plurality of musical instruments according to claim 1;
S2: providing each of the plurality of persons with one of the plurality of musical instruments;
S3: playing an audio recording or an adaptation of an audio recording of the predetermined song;
S4: sequentially and in synchronisation with the audio recording or adaptation, providing one or more visual identifiers visible to the plurality of persons, wherein each visual identifier is associated with a predetermined pitch,
   wherein, providing of each visual identifier prompts a group of the plurality of persons to play the musical instrument associated with them, such that a melody is formed which is in synchronisation with the predetermined song.

Furthermore, visual identifiers may be displayed on a screen visible to the plurality of persons. The identifiers may scroll along a track on the screen at a predetermined rate. The persons may be prompted to play their respective musical instrument when a particular identifier reaches a predetermined location on along the track.

In step S1, the plurality of musical instruments may be provided in disassembled configuration. Step S2 may comprise the sub-step of allowing each person to configure their respective musical instrument into assembled configuration, and in doing so, tuning their respective musical instrument to one of a predetermined number of pitches.

### BRIEF DESCRIPTION OF THE DRAWINGS

The disclosure will now be described in more detail, by way of example only, with reference to the accompanying drawings in which:

FIG. 1 shows an exploded perspective view of a musical instrument in accordance with a first example embodiment of the disclosure;

FIG. 2 shows a perspective view of the musical instrument of FIG. 1 in assembled form;

FIG. 3 shows a perspective view of the musical instrument of FIG. 1 in disassembled form;

FIG. 4 shows a top view of a main body of the musical instrument of FIG. 1, in flat-pack and disassembled form;

FIG. 5 shows a side view of the main body of the musical instrument of FIG. 1, in flat-pack and disassembled form;

FIG. 6 shows a side view of the musical instrument of FIG. 1 in assembled form;

FIG. 7 shows a front view of the musical instrument of FIG. 1 in assembled form;

FIG. 8 shows an exploded perspective view of a musical instrument in accordance with a second example embodiment of the disclosure, which differs from the example embodiment of FIG. 1, in that separate spacer members are included between a main body and a percussive bar;

FIG. 9 shows a perspective view of the musical instrument of FIG. 8 in assembled form;

FIG. 10 shows a perspective view of the musical instrument of FIG. 8 in disassembled form;

FIG. 11 shows a top view of a main body of the musical instrument of FIG. 8, in flat-pack and disassembled form;

FIG. 12 shows a side view of the main body of the musical instrument of FIG. 8, in flat-pack and disassembled form;

FIG. 13 shows a side view of the musical instrument of FIG. 8 in assembled form;

FIG. 14 shows a front view of the musical instrument of FIG. 8 in assembled form;

FIG. 15 shows an exploded perspective view of a musical instrument in accordance with a third example embodiment of the disclosure, in which a main body is formed from a number of independent body sections;

FIG. 16 shows a perspective view of the musical instrument of FIG. 15 in assembled form;

FIG. 17 shows a perspective view of the musical instrument of FIG. 15 in disassembled form;

FIG. 18 shows a side view of the musical instrument of FIG. 15 in assembled form;

FIG. 19 shows a front view of the musical instrument of FIG. 15 in assembled form;

FIG. 20 shows a cross-sectional perspective view of the musical instrument of FIG. 15; and

FIG. 21 shows a perspective view of a percussion mallet used with the musical instrument according to the disclosure.

### DETAILED DESCRIPTION OF THE ILLUSTRATED EMBODIMENTS

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

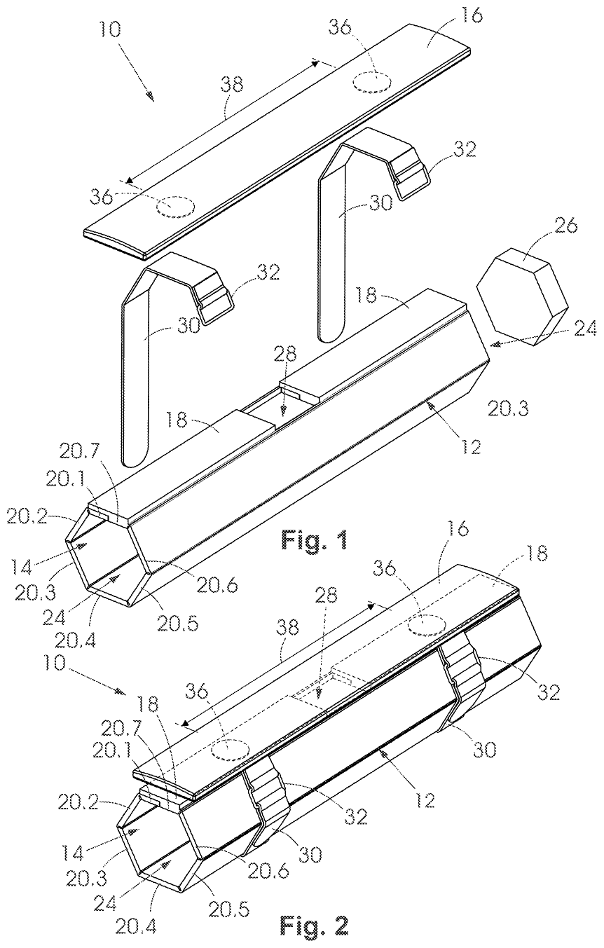

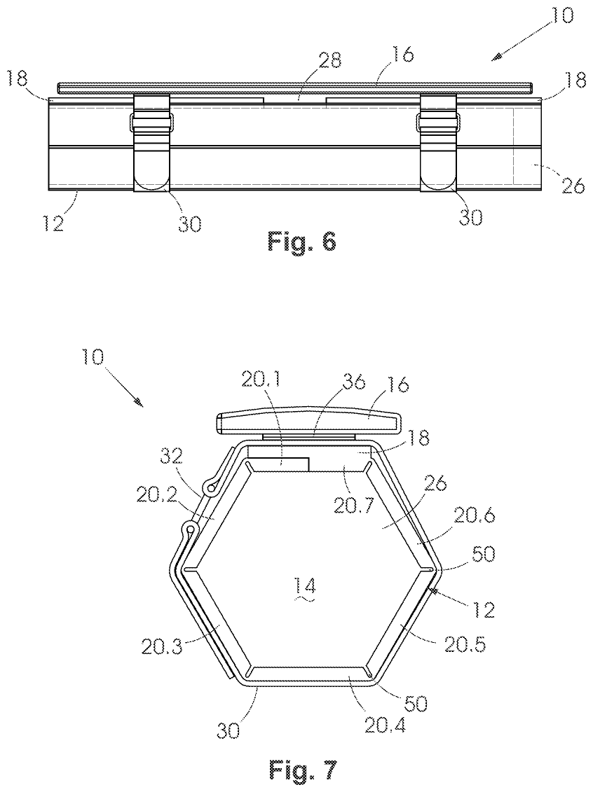

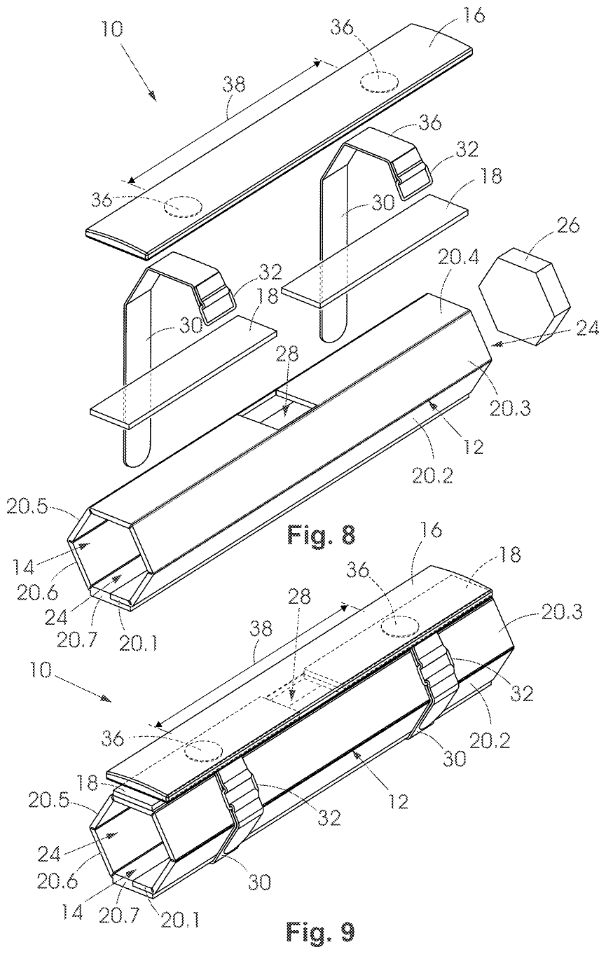

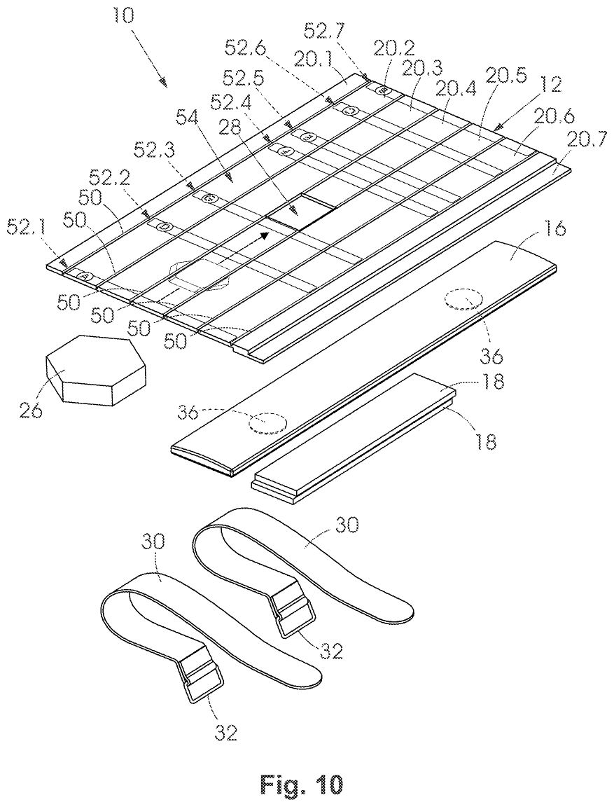

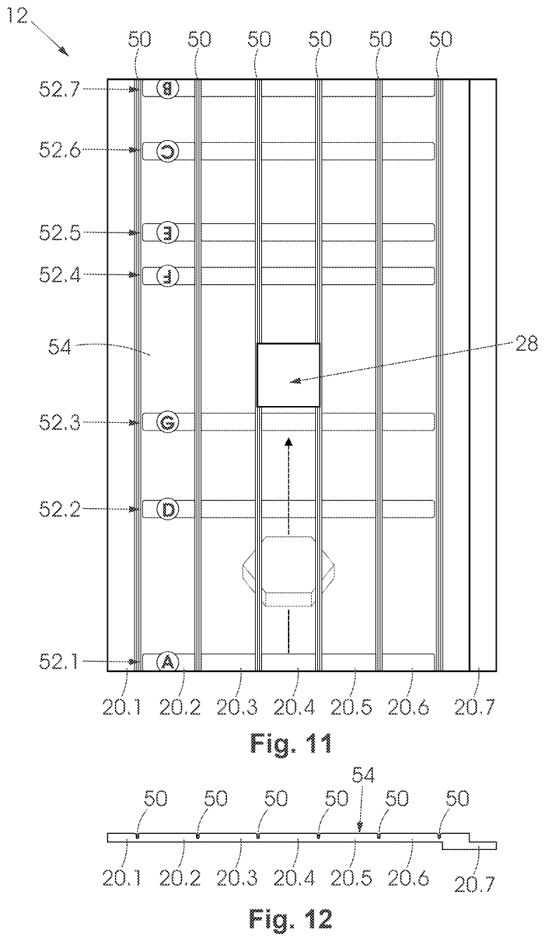

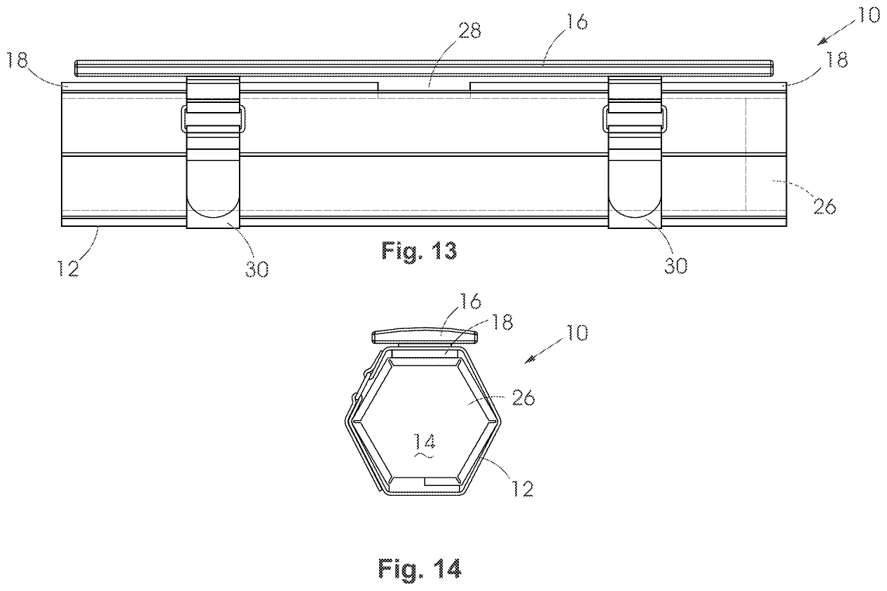

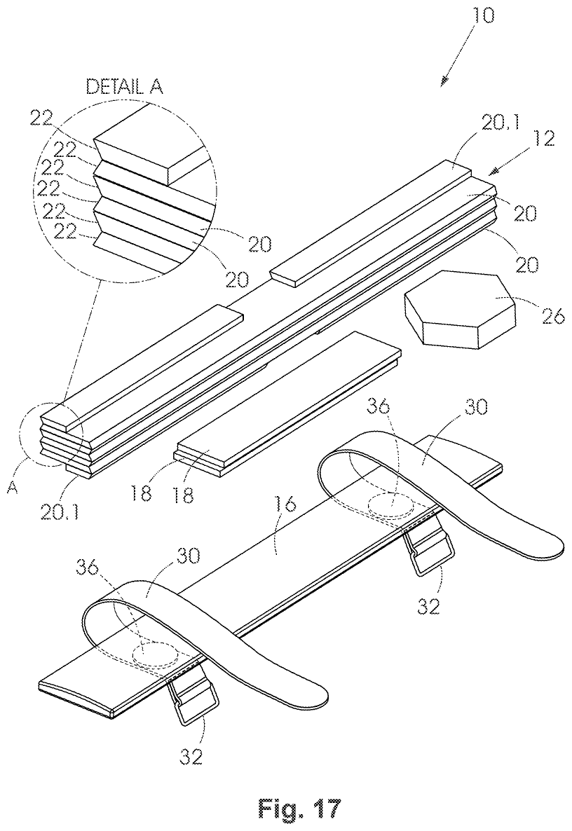

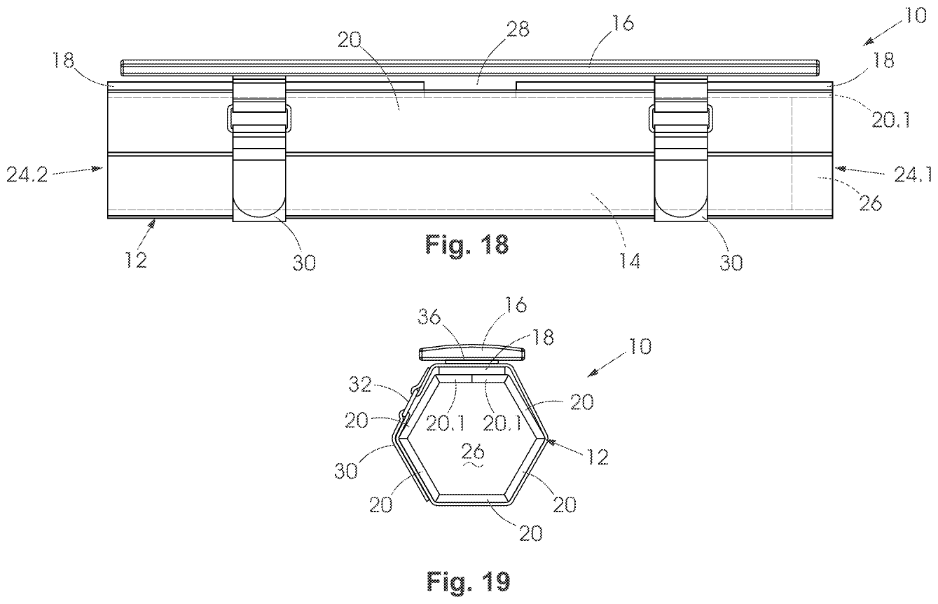

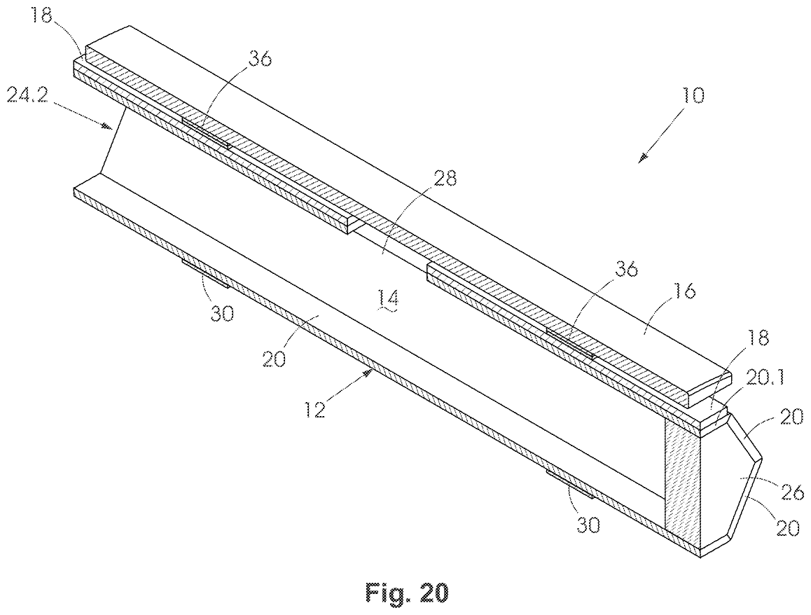

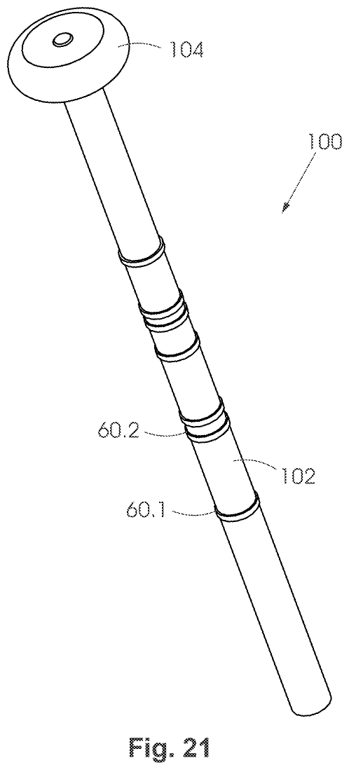

Referring to the drawings, in which like numerals indicate like features, a non-limiting example of a musical instrument (or simply “instrument”), in accordance with the disclosure, is generally indicated by reference numeral 10. The instrument 10 is configured as a percussion instrument. A first and preferable example embodiment of the instrument 10 is shown in FIGS. 1 to 8, while alternative embodiments of the instrument 10 is shown in FIGS. 9 to 20. Only the differences of the second embodiment when compared to the first embodiment will be discussed herein.

The instrument 10 comprises a main body 12 which, when assembled, that is, configured into an assembled configuration, defines a hollow chamber 14. As will become more apparent from what follows, the hollow chamber 14 is configured as a sound box. The instrument 10 further comprises a percussive bar 16 which, when the instrument 10 is assembled, is fixed relative to the main body 12. The percussive bar 16 is spaced from the main body 12 by at least a first, but typically two, spacer members 18. The spacer members 18 may take various forms, and the disclosure is not intended to be limited by the specific form of the spacer members. In general terms, the spacer members, albeit slightly, lifts the percussive bar 16 away from the main body. The spacer members 18 may, for example, take the form of:
separate members received between the main body 12 and the percussive bar 16;
spacer members integrally formed with the main body 12;
spacer members fixed or adhered to the main body 12;
straps (as discussed more fully below) used to hold the main body in assembled form; and/or
combinations of the aforementioned.

The instrument 10 is characterised in that the main body 12 is configurable into an assembled configuration and a disassembled configuration. For this purpose, the main body 12 typically comprises of a plurality of body segments 20 or panels, which are assembled or formed to form the main body 12 and when so assembled, defines the hollow chamber 14. After use, the instrument 10 can be disassembled or configured into a disassembled configuration by disassembling or breaking down the body segments 20. Typically, when disassembled, the body segments 20 may be stored in flat-packed configuration. The body segments may be substantially rectangular.

As shown in FIGS. 1 to 9, in the first embodiment, the main body 12 is manufactured from a paper-based material, such as cardboard, and the body segments 20 are therefore all integrally formed from a single sheet of cardboard. The different body segments 20 are defined between slits 50 which serve as lines of weakness and fold lines along which folds are created to form the main body. The slits 50 may, in embodiments not shown, be replaced by lines of weakness or simply pre-formed fold lines.

First and last body segments (20.1 and 20.7) collectively form a lap, half lap or shiplap joint which are brought together to become joined when assembling the main body 12.

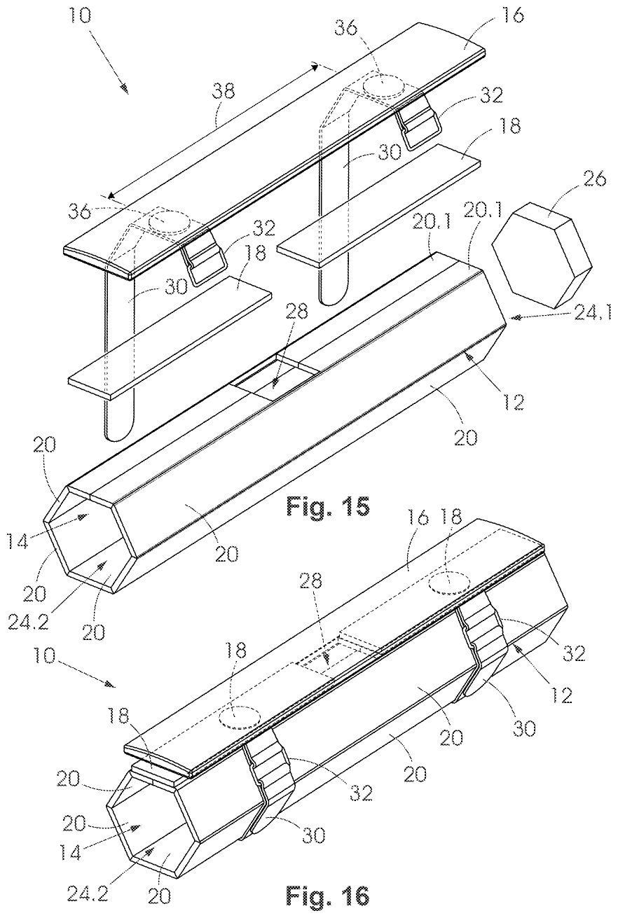

As shown in FIGS. 15 to 20, in the third embodiment, the body segments 20 may be separate and/or may be hingedly interconnected, such as by way of hinge members, or by way of flexible connection members. In such an embodiment, the body segments 20 may have bevelled edges 22 (as best shown in FIG. 12) which, when assembled, contact bevelled edges of an adjacent body segment 20 to form the shape of the main body. In the example embodiment shown in the figures (which has a hexagonally shaped main body), the bevelled edges 22 are bevelled at a bevel angle of 60 degrees.

The main body 12 is typically hexagonal in shape, even though the main body 12 may take other polygonal (such as square, pentagonal, and the like) or even substantially circular shapes.

When assembled, the main body 12 defines two open ends 24. A plug member 26 is received by the main body 12. The shape of the plug member 26 matches an inside shape of the main body 12 and therefore a shape of the hollow chamber 14 and fits snugly within the hollow chamber 14. The plug member is typically manufactured from cork.

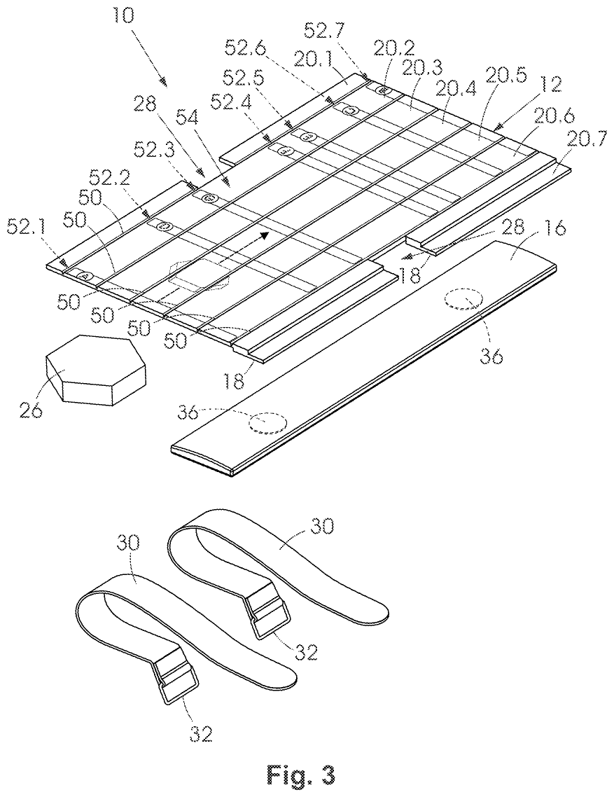

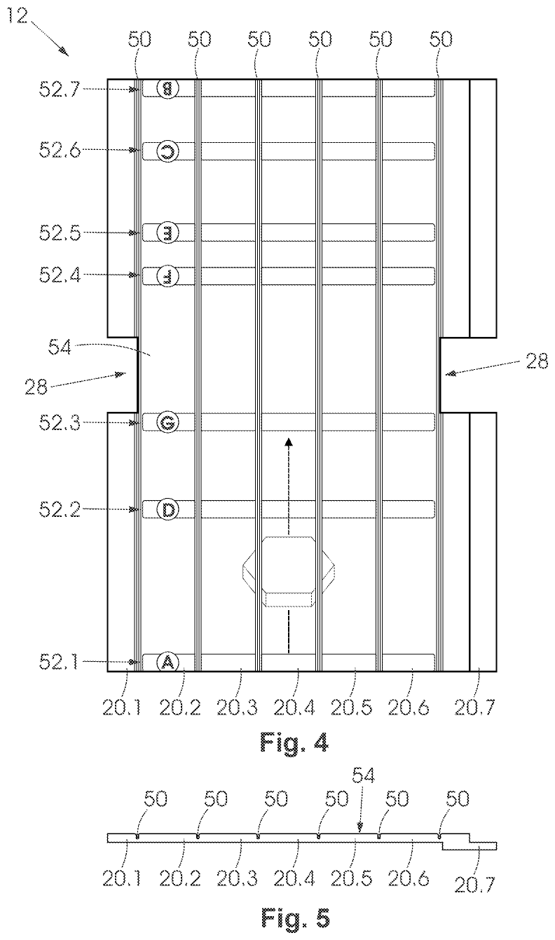

As best shown in FIGS. 3 and 4, a number of predetermined positions (referred to generally by reference numeral 52, with individual predetermined positions identified by different suffixes in the figures) are defined within the main body and in some embodiments, indicated by markings on an inner surface 54 of the main body. Each of these predetermined positions 52 indicates a discrete position in which the plug member 26 may be positioned when the instrument 10 is assembled. Therefore, during assembly, the plug member 26 is positioned in a predetermined and specific one of the positions 52, before the main body 12 is closed around the plug member to form the hollow chamber 14 and to finally configure the main body into the assembled configuration. The plug member 26 therefore determines a volume or size of the hollow chamber 14, and in doing so, impacts a pitch of the instrument 10. Therefore, each predetermined position 52 is associated with a predetermined pitch of the instrument 10. For example, if during assembly, the plug member 26 is placed in the first position 52.1, the instrument may be tuned to an A, while, if during assembly, the plug member 26 is placed in the third position 52.3, the instrument may be tuned to a G. In this way, the pitch of the instrument 10 may be determined during assembly thereof. Different individual instruments 10 may therefore be tuned to different pitches.

In another embodiment, a percussion mallet 100 (more fully discussed below) associated with the instrument 10 is provided with spaced markings on a stem 102 thereof. These markings may be provided as an alternative to providing markings on the inside surface of the main body. Therefore, in use, while the main body is assembled, the stem 102 of the mallet 100 may be arranged next to the main body 12 such that the markings on the stem serve as a guide to the predetermined positions of the main body.

When assembled, the main body 12 defines a sound hole 28 which communicates with the hollow chamber 14. Operatively, the sound hole 28 is located proximate the percussive bar 16 such that vibrations of the percussive bar 16 are propagated through the sound hole 28 into the hollow chamber. In use, the sound hole 28 is located underneath the percussive bar 16. The two spacer members 18 are arranged on opposite sides of the sound hole 28. The sound hole 28 is typically formed by one of the body segments 20 which is provided with a cut out. The sound hole may be square, rectangular, pentagonal or the like.

Two releasable strap members 30 are provided for securing the body segments 20 together in use, and therefore to form the main body 12. The strap members 30 extend around the main body 12 and exert an inward or radial distributed force about a periphery of the main body 12 to retain the main body 12 in assembled form. The strap members 30 may include ring members 32 and hook and loop fasteners 34 to fasten the straps.

The strap members 30 are releasably fixed to the percussive bar 16 via connection points 36 which typically take the form of hook and loop fasteners, or the like. The strap members 30 also retain the spacer members 18 (if present) in position. Since the percussive bar 16 is fixed to the strap members 30, the connection points 36 represent nodal points of the percussive bar 16. A spacing distance 38 between the connection points 36 has an impact on a pitch or tuning of the instrument 10.

At least a part of the instrument is marked with an identifier, to indicate the specific predetermined pitch to which the specific instrument 10 is tuned. For example, the markings on the inside surface 54 of the main body may have different colours, each associated with a different pitch. Therefore, for example, an instrument 10 where the plug member 26 is located at a purple marking on the inside of the main body may be tuned to a first predetermined pitch, such as A, and the like. It will be appreciated that the identifiers may take other forms too, such as letters, symbols, special characters or numerals, which may in some cases, be indicated on other parts of the instrument 10. When a number of instruments 10 are used concurrently, the identifiers may be used to group instruments 10 tuned to the same pitch into groups. The relevance of this will become apparent from the discussion further below.

Typically, the percussive bar 16 is manufactured from a wooden material, such as bamboo.

In use, a user may typically be presented with the instrument 10 in disassembled form (or configured in the disassembled configuration). Assembly of the instrument 10 comprises the steps of:
arranging the plug member 26 in a predetermined position;
bringing the body segments 20 of the main body 12 together to form the hollow chamber 12;
arranging the spacer members 18 on opposite sides of the sound hole 28 formed in the main body 12 (in cases where separate spacer members 18 are provided);
fastening the straps 30 around the main body to retain the main body in position; and
arranging the percussive bar 16 in position on top of the spacer members 18.

The instrument 10 is associated with a percussion mallet 100 or beater with which the instrument 10 is played. The percussion mallet 100 typically comprises a shaft 102 portion and a head portion 104. In use, the user holds the percussion mallet by the shaft portion and uses the head portion to strike or beat the percussive bar 16, typically towards a centre thereof. Another hand of the user is used to hold the instrument 10 by the main body 12.

When the percussive bar 16 is struck, the percussive bar 16 vibrates and resonates at a predetermined frequency (associated with the predetermined pitch). Waves generated by the vibrating percussive bar 16 propagates through the sound hole 28 into the hollow chamber 14 and are amplified. Sound waves are projected and leaves the main body through an open end of the main body.

One example use of the instrument 10 will now be discussed in more detail. It will be appreciated that the instrument is not limited to this specific use.

In this example, a group comprising a number of persons may each be provided with a separate instrument 10, and each instrument may be tuned to one of a predetermined number of predetermined pitches during assembly. In this case, the instruments may typically be tuned to four, five, six or more predetermined pitches such that four, five, six or more groups of instruments are distributed throughout the group of persons. Before use, each person may assemble the instrument 10 according to the steps outlined above.

Once assembled, the group may use their instruments 10, collectively to play a melody in unison. The melody may be associated with a predetermined song.

A system (not shown) may be provided for facilitating or conducting the playing of the melody by the group of persons.

The system may play an audio recording or track (or backtrack) of the predetermined song in the background. This audio recording may be an original and complete song or an adaptation of an original song. In cases where an adaptation of a song is played, the original song may be adapted to remove certain tracks (particularly, percussive, main melodic or even vocal tracks of the song). The group of persons may therefore use the instruments 10 to supplement the audio recording (and may even sing along to supplement or provide vocals of the song).

While playing the audio recording or track, a display which is visible to the group of persons, sequentially displays visual identifiers which are provided in synchronisation with parts or timestamps of the audio recording or track and which are associated with the identifiers of the instruments 10 and therefore the predetermined pitches. The displaying of each visual identifier prompts a group associated with an instrument of a similar predetermined pitch, to play their instrument at a predetermined time (in synchronisation). In this way, a melody is formed by the group of persons sequentially and in synchronisation playing their respective instruments 10.

The screen may display a track which moves in synchronisation with the predetermined song. The visual identifiers scroll along the track and indicate a time at which an associated group of persons should play their instruments 10 when a predetermined point or location along the track is reached. The predetermined point or location may typically be a bar or line which extends across the track.

It will be appreciated that the assembly of the instruments together with the subsequent playing thereof according to the method outlined above, may serve as a group activity during team building exercises. This may also be used for educational purposes. Configuring the instrument in disassembled configuration eases transportation thereof.

It will be appreciated that the above description only provides example embodiments of the disclosure and that there may be many variations without departing from the spirit and/or the scope of the disclosure.

For example, in one variation, the instrument 10 may be mounted to a base or structure, which removes the need for the user to hold the instrument 10 by the main body 12 during use. In such a case, more than one instrument 10 tuned to different pitches may be mounted side-by-side, to allow a single user to play the more than one instrument 10 and to play a melody.

It will be easily understood from the present description that the particular features of the present disclosure, as generally described and illustrated in the figures, can be arranged and designed according to a wide variety of different configurations. In this way, the description of the present disclosure and the related figures are not provided to limit the scope of the disclosure but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described one embodiment can be isolated from the other characteristics of this embodiment unless otherwise expressed.

What is claimed:

1. A musical instrument, comprising:
a main body operatively defining a hollow chamber configured as a sound box;
a percussive bar operatively fixed relative to the main body and spaced therefrom by at least a first spacer member,
characterised in that the main body is configurable in one of an assembled configuration and disassembled configuration.

2. The musical instrument according to claim 1, wherein the main body is disassembled into a flat-pack configuration when in the disassembled configuration.

3. The musical instrument according to claim 1, wherein the main body, when in the assembled configuration, is hexagonal and defines a hexagonal hollow chamber.

4. The musical instrument according to claim 1, wherein the main body comprises a plurality of main body segments which are substantially rectangular with bevelled edges which interact when in the assembled configuration to form the main body and define the hollow chamber.

5. The musical instrument according to claim 1, wherein the main body is formed from a paper-based material and wherein the main body comprises a plurality of main body segments which are defined between one of: i) lines of weakness; ii) fold lines; and iii) slits defining fold lines.

6. The musical instrument according to claim 5, wherein a first and last main body segment define a half lap or shiplap joint which, when the main body is configured in the assembled configuration, is joined to form the main body and define the hollow chamber.

7. The musical instrument according to claim 1, wherein the main body comprises two open ends, and wherein the musical instrument further comprises a plug member having an external shape commensurate with a cross-sectional shape of the hollow chamber.

8. The musical instrument according to claim 7, wherein the plug member is arranged in one of a number of predetermined positions within the main body to define a volume of the hollow chamber and wherein each of the predetermined positions is associated with a predetermined pitch, such that positioning the plug member at a predetermined position configures or tunes the musical instrument into a predetermined pitch.

9. The musical instrument according to claim 8, wherein the predetermined positions are indicated by one of: i) markings on an inner surface of the main body and ii) markings on a stem portion of a mallet, wherein the mallet forms part of the musical instrument and wherein the stem portion with the associated markings is placed proximate the main body during assembly thereof to serve as a guide for placing the plug member in one of the predetermined positions.

10. The musical instrument according to claim 7, wherein the plug member is positioned within the main body during assembly of the musical instrument, thereby to configure or tune the musical instrument into a predetermined pitch.

11. The musical instrument according to claim 1, wherein the main body operatively defines a sound hole which is arranged proximate the percussive bar and wherein the sound hole is provided in communication with the hollow chamber.

12. The musical instrument according to claim 11, comprising two spacer members operatively arranged on opposite sides of the sound hole.

13. The musical instrument according to claim 1, further comprising strap members which operatively extend around the main body releasably to retain the main body in the assembled configuration.

14. The musical instrument according to claim 13, wherein the percussive bar is releasably fixed to one of: i) the strap members and ii) the at least first spacer member.

15. The musical instrument according to claim 1, wherein at least a portion of the musical instrument is marked with an identifier which is linked to a predetermined pitch.

16. The musical instrument according to claim 15, wherein the identifier comprises one of: a colour; a letter; a numeral; and a special character.

17. The musical instrument according to claim 1, wherein the percussive bar is manufactured from bamboo.

18. A method for a plurality of persons to play a melody associated with a predetermined song, in unison, the method comprising the steps of:
S1: providing a plurality of musical instruments according to claim 1;
S2: providing each of the plurality of persons with one of the plurality of musical instruments;
S3: playing an audio recording or an adaptation of an audio recording of the predetermined song;
S4: sequentially and in synchronisation with the audio recording or adaptation, providing one or more visual identifiers visible to the plurality of persons, wherein each visual identifier is associated with a predetermined pitch,
wherein, providing of each visual identifier prompts a group of the plurality of persons to play the musical instrument associated with them, such that a melody is formed which is in synchronisation with the predetermined song.

19. The method according to claim 18, wherein visual identifiers are displayed on a screen visible to the plurality of persons, wherein the identifiers scroll along a track on the screen at a predetermined rate, and wherein the persons are prompted to play their respective musical instrument when a particular identifier reaches a predetermined location on along the track.

20. The method according to claim 18, wherein, in step S1, the plurality of musical instruments are provided in a disassembled configuration, and wherein step S2 comprises the sub-step of allowing each person to configure their respective musical instrument into assembled configuration, and while doing so, tuning their respective musical instrument to one of a predetermined number of pitches.
